(19) United States
(12) Patent Application Publication
(10) Pub. No.: US 2026/0066945 A1
(43) Pub. Date: Mar. 5, 2026

(54) IN-BAND EMISSION MITIGATION FOR IN-VEHICLE COMMUNICATION NETWORKS

(71) Applicant: Infineon Technologies Americas Corp., El Segundo, CA (US)

(72) Inventors: Shaowu HUANG, Los Altos, CA (US); Dance WU, Palo Alto, CA (US)

(21) Appl. No.: 19/319,213

(22) Filed: Sep. 4, 2025

Related U.S. Application Data
(60) Provisional application No. 63/690,773, filed on Sep. 4, 2024.

(51) Int. Cl. H04B 3/32; H04B 15/02

(52) U.S. Cl. CPC H04B 3/32; H04B 15/02

(57) ABSTRACT

A communication system for use in a vehicle includes a first communication device configured for operation in the vehicle, and a second communication device configured for operation in the vehicle. A cable assembly communicatively couples the first communication device with the second communication device. A signal suppressing device is coupled to the cable assembly at a location proximate to an end of the cable assembly. The signal suppressing device is configured to suppress signals in a frequency range corresponding to in-band radiated emission (RE).

### CROSS REFERENCES TO RELATED APPLICATIONS

This application claims the benefit of U.S. Provisional Patent App. No. 63/690,773, entitled “UTP In-band Emission Mitigation Technique,” filed on Sep. 4, 2024, the disclosure of which is expressly incorporated herein by reference in its entirety for all purposes.

### FIELD OF TECHNOLOGY

The present disclosure relates generally to in-vehicle communication networks, and more particularly to mitigating electromagnetic interference in a vehicle.

### BACKGROUND

In-vehicle communication networks permit components within a vehicle to exchange data. For example, Controller Area Network (CAN) is a communication standard that is widely used in the automotive industry. Additionally, automotive Ethernet is a type of Ethernet network adapted to the automotive environment, which enables high-speed data transfer within vehicles. Automotive Ethernet provides a significantly higher transmission rate as compared to CAN, which allows, among other things, the replacement of multiple CAN cables with a single Ethernet link. As a result, automotive Ethernet reduces the weight of wiring harnesses in vehicles while providing higher bandwidth data transmission compared to CAN. Because of the advantages of automotive Ethernet over CAN and because of the increasing adoption of advanced automotive technologies that require higher data rates, the use of automotive Ethernet in the automotive industry is significantly increasing.

In-band radiated emission (RE) is a drawback with using unshielded twisted pair (UTP) cables in automotive Ethernet. Mode-conversion on package, printed circuit board (PCB), connector, and cable can cause problematic common-mode currents on a UTP cable. Additionally, unshielded cables like UTP cables are inherently very effective antennas. With excessive common-mode currents on a UTP cable, in-band RE can be very high. Additionally, cable resonances associated with multiple reflections between cable end points are difficult to suppress and may further exacerbate in-band RE.

In-vehicle networks are becoming more complex over time with more unshielded cabling, and thus in-band RE levels in vehicle networks are tending to increase.

### SUMMARY

In an embodiment, a communication system for use in a vehicle comprises: a first communication device configured for operation in the vehicle; a second communication device configured for operation in the vehicle; a cable assembly configured to communicatively couple the first communication device with the second communication device; and a first signal suppressing device coupled to the cable assembly, the first signal suppressing device configured to suppress signals in a frequency range corresponding to in-band radiated emission (RE), the first signal suppressing device located proximate to a first end of the cable assembly.

In another embodiment, a method for operating a communication system in a vehicle includes: exchanging communication signals between a first communication device and a second communication device via a cable assembly; and attenuating, by a first signal suppressing device coupled to the cable assembly proximate to a first end of the cable assembly, signals in a frequency range corresponding to in-band radiated emission (RE).

In yet another embodiment, a cable assembly for use in a vehicle comprises: one or more cable segments; a first plug connected to a first end of the one or more cable segments; a second plug connected to a second end of the one or more cable segments; and a first signal suppressing device coupled to the cable assembly, the first signal suppressing device configured to suppress signals in a frequency range corresponding to in-band radiated emission (RE) in the vehicle, the first signal suppressing device located proximate to the first end of the cable assembly.

In still another embodiment, a method for manufacturing a cable assembly for a communication network in a vehicle includes: attaching a first plug to a first end of one or more cable segments of the cable assembly; attaching a second plug to a second end of one or more cable segments of the cable assembly; and coupling a first signal suppression device to the cable assembly at a first location proximate to the first end of the cable assembly.

### BRIEF DESCRIPTION OF THE DRAWINGS

FIG. 1 is a simplified diagram of an example vehicle in which various aspects, features, and elements described herein are implemented in accordance with an embodiment of this disclosure.

FIG. 2 is a simplified diagram of an example communication system for use in a vehicle such as the vehicle of FIG. 1, according to an embodiment.

FIG. 3 is a simplified diagram of another example communication system for use in a vehicle such as the vehicle of FIG. 1, according to another embodiment.

FIG. 4 is a simplified diagram of another example communication system for use in a vehicle such as the vehicle of FIG. 1, according to another embodiment.

FIG. 5 is a simplified diagram of another example communication system for use in a vehicle such as the vehicle of FIG. 1, according to another embodiment.

FIG. 6 is a flow diagram of an example method for operating a communication network in a vehicle such as the vehicle of FIG. 1, according to an embodiment.

FIG. 7 is a flow diagram of an example method for manufacturing a cable assembly for a communication network in a vehicle such as the vehicle of FIG. 1, according to an embodiment.

### DETAILED DESCRIPTION

Automotive Ethernet standards from the Institute of Electrical and Electronics Engineers (IEEE) specify medium dependent interface (MDI) power spectral density (PSD) upper and lower limits. Thus, the amount that PSD can be lowered to reduce in-band radiated emission (RE) is often limited. Moreover, lowering PSD can cause other signal integrity and electromagnetic compatibility (EMC) problems in a vehicle. Currently, vehicle manufacturers tend to accept existing levels of in-band RE and design their vehicle systems to account for the in-band RE.

Embodiments of attenuation techniques for reducing in-band RE in an in-vehicle communication network are described below. For example, a signal suppressing device is coupled to a cable that communicatively couples two or more electrical components of the vehicle. The signal suppressing device is located proximate to a first end of the cable and is configured to suppress signals in a frequency range corresponding to in-band RE, in an embodiment. The signal suppressing device comprises an electromagnetic signal absorbing material coupled around a portion of the cable proximate to the end of the cable, in an embodiment. In another embodiment, the signal suppressing device comprises a filter (e.g., the filter comprising a shunt capacitor) that is electrically coupled to a conductor of the cable proximate to the end of the cable.

In at least some embodiments and/or applications related to 1000Base-T1 automotive Ethernet, attenuation techniques such as described herein significantly reduce in-band radiation emission (RE) in unshielded twisted pair (UTP) cables over problematic frequency ranges (e.g., 100 MHZ˜600 MHZ). In other embodiments, the same or similar attenuation techniques reduce in-band RE in connection with other types of communications and/or over other types of cables and/or over other suitable frequency ranges.

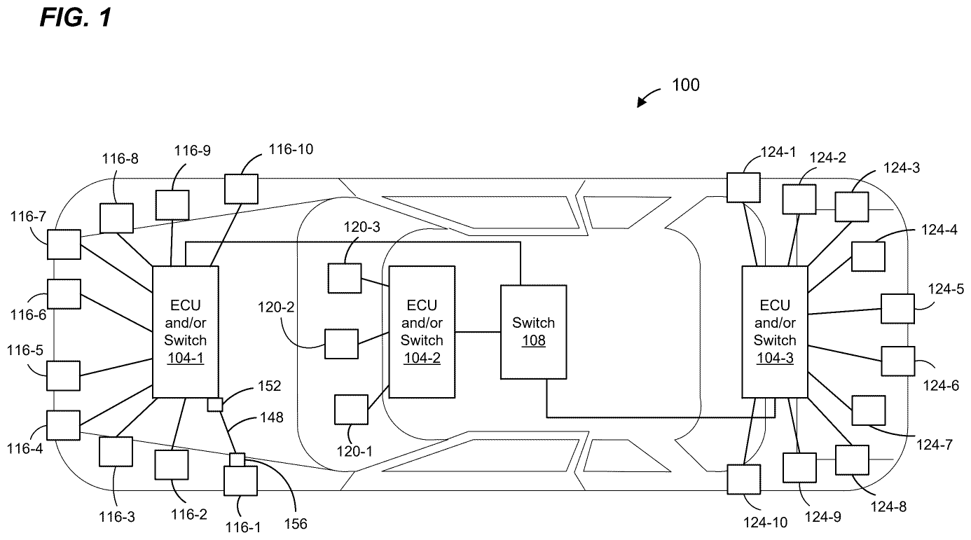

FIG. 1 is a simplified diagram of an example vehicle 100 in which various aspects, features, and elements described herein are implemented in accordance with an embodiment of this disclosure. The vehicle 100 includes a communications network (or simply “network”) that enables communication among different subsystems in the vehicle 100. The network includes a plurality of electronic control units (ECUs) 104 communicatively coupled to a network switch 108. In an embodiment, one or more of the ECUs 104 perform operations corresponding to advanced drive assistance (ADAS) functions. In another embodiment, one or more of the ECUs 104 additionally or alternatively perform operations corresponding to in-vehicle infotainment (IVI) functions. In another embodiment, one or more of the ECUs 104 additionally or alternatively perform operations corresponding to engine control and/or monitoring functions. In other embodiments, one or more of the ECUs 104 additionally or alternatively perform other suitable operations.

Although three ECUs 104 are illustrated in FIG. 1, the vehicle 100 includes other suitable numbers of ECUs in other embodiments, such as one, two, four, five, six, etc.

The network switch 108 is communicatively connected to the ECUs 104 via respective communication links. In various embodiments, the communication links correspond to suitable cables such as Ethernet 100BASE-T1 cables, Ethernet 1000BASE-T1 cables, IEEE 802.3ch compliant Multi-Gig Automotive Ethernet 2.5GBASE-T1 cables, 5GBASE-T1 cables, etc. In other embodiments, the communication links correspond to other suitable cables.

Each of the ECUs 104 comprises a respective processor (not shown) that executes machine readable instructions stored in a respective memory device (not shown) of the ECU 104, in an embodiment.

Each of one or more of the ECUs 104 also includes a respective network switch, in some embodiments. In another embodiment, none of the ECUs 104 includes a network switch.

The network switch 108 includes a plurality of network interfaces. In an embodiment, a first network interface of the network switch 108 is communicatively connected to a network interface of the ECU 104-1; a second network interface of the network switch 108 is communicatively connected to a network interface of the ECU 104-2; and a third network interface of the network switch 108 is communicatively connected to a network interface of the ECU 104-3.

A network switch of (or communicatively coupled to) the ECU 104-1 is communicatively connected to vehicle subsystem assemblies 116 via respective communication links. In various embodiments, the communication links correspond to suitable cables such as cables used with Ethernet 100BASE-T1, Ethernet 1000BASE-T1, IEEE 802.3ch compliant Multi-Gig Automotive Ethernet 2.5GBASE-T1, 5GBASE-T1, 10BASE-TIS, etc. In other embodiments, the communication links correspond to other suitable cables.

The vehicle subsystem assemblies 116 includes respective Ethernet interface devices and one or more of: i) one or more sensors, ii) one or more actuators, iii) one or more control modules (e.g., comprising a hardware state machine and/or a processor that executes machine readable instructions stored in a memory device), etc., according to various embodiments.

Similarly, a network switch of (or communicatively coupled to) the ECU 104-2 is communicatively connected to vehicle subsystem assemblies 120 via respective communication links; and the network switch of the ECU 104-3 is communicatively connected to vehicle subsystem assemblies 124 via respective communication links.

The vehicle subsystem assemblies 120 and 124 have structures similar to the vehicle subsystem assemblies 116, in an embodiment, but at least some of the subsystem assemblies 116, 120, and 124 correspond to different functionality of the vehicle 100, in some embodiments. For example, at least some of the subsystem assemblies 116 are associated with advanced drive assistance (ADAS) functions and/or engine control and/or monitoring functions; at least some of the subsystem assemblies 120 are associated with in-vehicle infotainment (IVI) functions; and at least some of the subsystem assemblies 124 are associated with hatch operation and/or parking assistance, according to an embodiment. In other embodiments, one or more of the ECUs 104 additionally or alternatively perform other suitable operations.

A cable 148 communicatively couples the ECU 104 and the subsystem assembly 116-1. A first signal suppressing device 152 is coupled to the cable 148. The first signal suppressing device 152 is located proximate to a first end of the cable 148 and is configured to suppress signals in a frequency range corresponding to in-band RE. Additionally, a second signal suppressing device 156 is coupled to the cable 148. The second signal suppressing device 156 is located proximate to a second end of the cable 148 and is also configured to suppress signals in the frequency range corresponding to the in-band RE, in an embodiment. In another embodiment, the second signal suppressing device 156 is omitted. In other embodiments, one or more additional signal suppressing devices are coupled to the cable 148.

The first signal suppressing device 152 comprises an electromagnetic signal absorbing material around the cable 148 proximate to the first end of the cable 148, in an embodiment. Additionally or alternatively, the second signal suppressing device 156 comprises an electromagnetic signal absorbing material around the cable 148 proximate to the second end of the cable 148, in another embodiment. Examples of electromagnetic signal absorbing materials used for the first signal suppressing device 152 and/or the second signal suppressing device 156, in some embodiments, are described further below.

In another embodiment, the first signal suppressing device 152 comprises a first filter coupled to a conductor of the cable 148, the first filter located proximate to the first end of the cable 148 and being configured to suppress signals in the frequency range corresponding to the in-band RE. Additionally or alternatively, the second signal suppressing device 156 comprises a second filter coupled to the conductor of the cable 148 (or another conductor of the cable 148), the second filter located proximate to the second end of the cable 148 and being configured to suppress signals in the frequency range corresponding to the in-band RE, in another embodiment. Examples of filters used for the first signal suppressing device 152 and/or the second signal suppressing device 156, in some embodiments, are described further below.

Although only one cable 148 is illustrated in FIG. 1 as being coupled to signal suppressing devices 152, 156, each of one or more other cables in the vehicle 100 is coupled to a respective one or more signal suppressing devices the same as or similar to the signal suppressing devices 152, 156, in some embodiments.

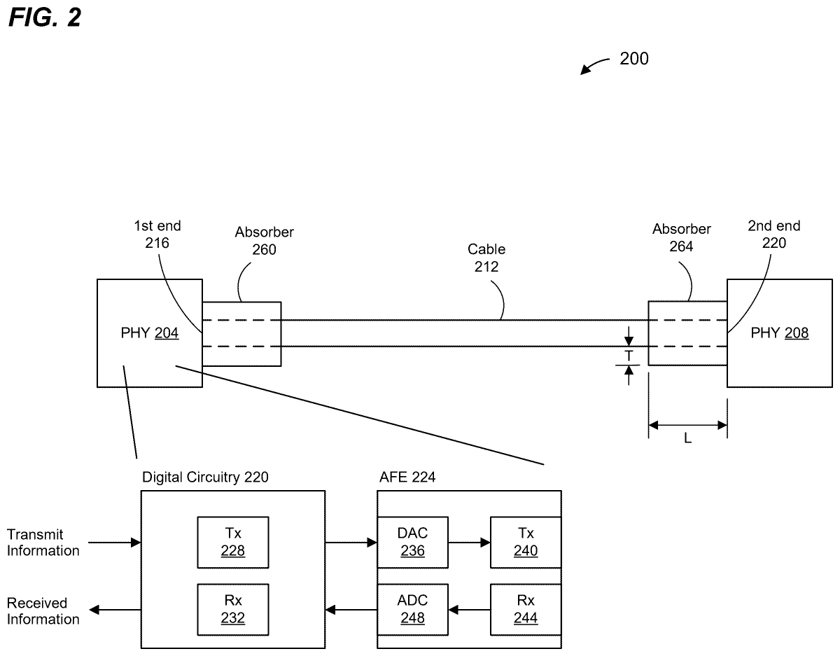

FIG. 2 is a simplified diagram of an example communication system 200 for use in a vehicle, according to an embodiment. The communication system 200 is utilized in the vehicle 100 of FIG. 1, in an embodiment, and FIG. 2 is described with reference to FIG. 1 merely for explanatory purposes. In other embodiments, the communication system 200 is utilized in another suitable vehicle different than the vehicle 100. In other embodiments, the vehicle 100 includes suitable communication systems different than the example communication system 200.

The communication system 200 includes physical layer (PHY) circuitry 204 of a first communication device and PHY circuitry 208 of a second communication device. The PHY circuitry 204 is communicatively coupled to the PHY circuitry 208 via a cable 212. The cable 212 comprises cable suitable for use in an in-vehicle communication system such as cables used with Ethernet 100BASE-T1, Ethernet 1000BASE-T1, IEEE 802.3ch compliant Multi-Gig Automotive Ethernet 2.5GBASE-T1, 5GBASE-T1, 10BASE-TIS, etc. In other embodiments, the cable 212 comprises another suitable cable.

In an embodiment, the PHY circuitry 204 corresponds to a first Ethernet network interface of the first communication device, and the PHY circuitry 208 corresponds to a second Ethernet network interface of the second communication device.

Referring to FIG. 1, in an embodiment, the first communication device having the PHY circuitry 204 corresponds to a vehicle subsystem assembly 116, 120, 124 and the second communication device having the PHY circuitry 208 corresponds to an ECU 104 or a network switch coupled to the ECU 104. In another embodiment, the first communication device having the PHY circuitry 204 corresponds to an ECU 104 and the second communication device having the PHY circuitry 208 corresponds to the network switch 108. In another embodiment, the first communication device having the PHY circuitry 204 corresponds to the network switch 108 and the second communication device having the PHY circuitry 208 corresponds to another network switch in the vehicle 100.

The PHY circuitry 204 comprises digital processing circuitry 220 coupled to analog front end (AFE) circuitry 224. The AFE circuitry 224 is communicatively coupled to the cable 212. The digital processing circuitry 220 includes digital transmit circuitry 228 and digital receive circuitry 232, both of which are coupled to the AFE circuitry 224. The digital transmit circuitry 228 is configured to receive digital transmit information and generate a digital transmit signal based on the digital transmit information, the digital transmit signal encoding the digital transmit information. The digital receive circuitry 232 is configured to receive a digital receive signal from the AFE 224 and decode received information from the digital receive signal.

The AFE circuitry 224 includes a digital-to-analog converter (DAC) 236 that is configured to convert the digital transmit signal from the digital transmit circuitry 228 to an analog signal. Analog transmit circuitry 240 is coupled to an output of the DAC 236. The analog transmit circuitry 240 is configured to process the analog signal output by the DAC 236 to generate an analog transmit signal. The analog transmit circuitry 240 includes an analog reconstruction filter (e.g., an anti-imaging filter) that is configured to smooth the analog output of the DAC 236. The analog transmit circuitry 240 optionally includes one or more other analog filters (e.g., a lowpass filter, a bandpass filter, etc.), according to another embodiment. The analog transmit circuitry 240 additionally or alternatively includes an amplifier and/or drive circuitry, according to another embodiment.

The AFE circuitry 224 also includes analog receive circuitry 244 coupled to an analog-to-digital converter (ADC) 248. The analog receive circuitry 244 is configured to process a received analog signal for sampling by the ADC 248. The ADC 248 generates the digital received signal that is processed by the digital receive circuitry 232, in an embodiment. The analog receive circuitry 244 includes an anti-aliasing filter that is configured to restrict a bandwidth of the analog receive signal prior to sampling by the ADC 248 to reduce aliasing, according to an embodiment. The analog receive circuitry 244 optionally includes one or more other analog filters (e.g., a lowpass filter, a bandpass filter, etc.), in another embodiment. The analog receive circuitry 244 additionally or alternatively includes an amplifier, according to another embodiment.

The cable 212 includes i) a first plug (not shown) connected to a first end 216 of the cable 212, and ii) a second plug (not shown) connected to a second end 220 of the cable 212, in an embodiment. The PHY circuitry 204 is coupled to a first socket (not shown) that is configured to accept the first plug of the cable 212, and the PHY circuitry 208 is coupled to a second socket (not shown) that is configured to accept the second plug of the cable 212. In an embodiment, when the first plug of the cable 212 is inserted in the first socket coupled to the PHY circuitry 204 and the second plug of the cable 212 is inserted in the second socket coupled to the PHY circuitry 208, the PHY circuitry 204 and the PHY circuitry 208 are communicatively connected via the cable 212.

A first signal suppressing device 260 is coupled to the cable 212 proximate to the first end 216 of the cable 212. The first signal suppressing device 260 comprises a material configured to absorb electromagnetic signals corresponding to in-band RE. For example, the first signal suppressing device 260 (sometimes referred to as the “first absorption material 260”) comprises a material configured to absorb electromagnetic signals that fall within or overlap with frequencies of communication signals conveyed by the cable 212, in an embodiment.

A second signal suppressing device 264 is coupled to the cable 212 proximate to the second end 220 of the cable 212. The second signal suppressing device 264 comprises the material configured to absorb electromagnetic signals corresponding to in-band RE. For example, the second signal suppressing device 264 (sometimes referred to as the “second absorption material 264”) comprises the material configured to absorb electromagnetic signals that fall within or overlap with the frequencies of communication signals conveyed by the cable 212, in an embodiment.

The first absorption material 260 circumscribes the cable 212 and is located proximate to the first end 216 of the cable 212, in an embodiment. In an embodiment, when the cable includes the first plug at the first end 216, the first absorption material 260 being located proximate to the first end 216 corresponds to the first absorption material 260 being located proximate to the first plug. In an embodiment, the first absorption material 260 is located within 5 centimeters (cm) of the first end 216 of the cable 212 (e.g., within 5 cm of the first plug). In another embodiment, the first absorption material 260 is located within 10 cm of the first end 216 of the cable 212 (e.g., within 10 cm of the first plug). In another embodiment, the first absorption material 260 is located within 20 cm of the first end 216 of the cable 212 (e.g., within 20 cm of the first plug). In another embodiment, the first absorption material 260 is located within 30 cm of the first end 216 of the cable 212 (e.g., within 30 cm of the first plug). In another embodiment, the first absorption material 260 is located within 40 cm of the first end 216 of the cable 212 (e.g., within 40 cm of the first plug). In another embodiment, the first absorption material 260 is located greater than 40 cm from the first end 216 of the cable 212 (e.g., greater than 40 cm from the first plug). At least in some embodiments and/or implementations, performance improves as the first absorption material 260 is located closer to the first end 216. In other embodiments and/or implementations, performance may not improve as the first absorption material 260 is located closer to the first end 216.

The second absorption material 264 circumscribes the cable 212 and is located proximate to the second end 220 of the cable 212, in an embodiment. In an embodiment, when the cable includes the second plug at the second end 220, the second absorption material 264 being located proximate to the second end 220 corresponds to the second absorption material 264 being located proximate to the second plug. In an embodiment, the second absorption material 264 is located within 5 cm of the second end 220 of the cable 212 (e.g., within 5 cm of the second plug). In another embodiment, the second absorption material 264 is located within 10 cm of the second end 216 of the cable 212 (e.g., within 10 cm of the second plug). In another embodiment, the second absorption material 264 is located within 20 cm of the second end 220 of the cable 212 (e.g., within 20 cm of the second plug). In another embodiment, the second absorption material 264 is located within 30 cm of the second end 220 of the cable 212 (e.g., within 30 cm of the second plug). In another embodiment, the second absorption material 264 is located within 40 cm of the second end 220 of the cable 212 (e.g., within 40 cm of the second plug). In another embodiment, the second absorption material 264 is located greater than 40 cm from the second end 220 of the cable 212 (e.g., greater than 40 cm from the second plug). At least in some embodiments and/or implementations, performance improves as the second absorption material 264 is located closer to the second end 220. In other embodiments and/or implementations, performance may not improve as the second absorption material 264 is located closer to the second end 220.

The first absorption material 260 and the absorption material 264 each have a length L. In an embodiment, the length L is approximately 10 cm (e.g., 10 cm±1 cm). In another embodiment, the length L is approximately 20 cm (e.g., 20 cm±2 cm). In another embodiment, the length L is approximately 30 cm (e.g., 30 cm±3 cm). In another embodiment, the length L is between approximately 5 cm and approximately 40 cm (e.g., between 4.9 cm and 44 cm). In other embodiments, the length L is another suitable length. At least in some embodiments and/or implementations, performance improves as the length L increases, but with diminishing returns. Additionally, costs also increase as the length L increases.

In some embodiments, the first absorption material 260 and the absorption material 264 have different suitable lengths.

The first absorption material 260 and the absorption material 264 each have a thickness T. In an embodiment, the thickness T is approximately 10 cm (e.g., 1 cm±1 millimeter (mm)). In another embodiment, the thickness T is approximately 2 cm (e.g., 2 cm±2 mm). In another embodiment, the thickness T is approximately 4 cm (e.g., 4 cm±4 mm). In another embodiment, the length L is between approximately 1 cm and approximately 5 cm (e.g., between 0.9 cm and 5.5 cm). In other embodiments, the thickness T is another suitable thickness. At least in some embodiments and/or implementations, performance improves as the thickness T increases, but with diminishing returns. Additionally, costs also increase as the thickness T increases.

In some embodiments, the first absorption material 260 and the absorption material 264 have different suitable thicknesses.

In some embodiments, the first absorption material 260 and the second absorption material 264 comprise a suitable material such as a polymeric elastomer, a dielectric foam, etc., that incorporates another material that absorbs and/or dissipates electromagnetic waves, such as conductive carbon, a ferrite, or another suitable material. In some embodiments, the first absorption material 260 and the absorption material 264 comprise different suitable materials. In an embodiment, the first absorption material 260 and/or the second absorption material 264 comprise a microwave absorbing material. In some embodiments, the first absorption material 260 and the second absorption material 264 comprise a same material. In other embodiments, the first absorption material 260 and the second absorption material 264 comprise different materials.

Although two signal suppressing devices 260, 264 are illustrated in FIG. 2, one or more additional signal suppressing devices are also coupled to the cable 212 in other embodiments.

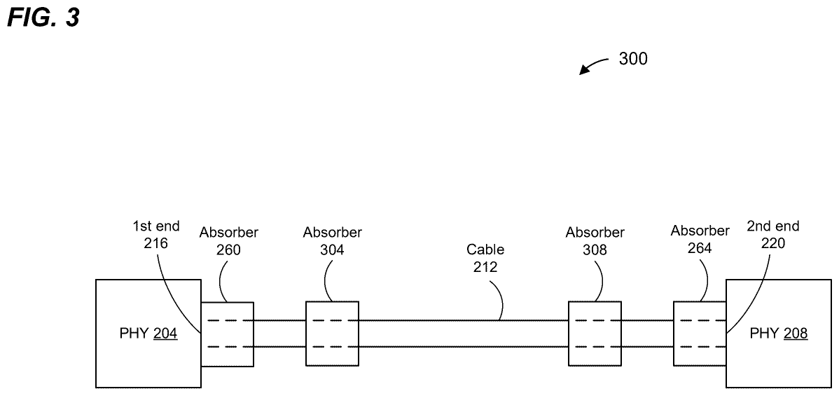

FIG. 3 is a simplified diagram of another example communication system 200 for use in a vehicle, according to another embodiment. The communication system 300 is a variation of the communication system 200 of FIG. 2, with additional signal suppressing devices 304, 308 coupled to the cable 212.

The signal suppressing device 304 is coupled to the cable 212 and spaced apart from the first absorption material 260. The signal suppressing device 304 is proximate to the first absorption material 260, but spaced apart from the first absorption material 260, in an embodiment. The signal suppressing device 304 comprises the material configured to absorb electromagnetic signals corresponding to in-band RE. For example, the signal suppressing device 304 (sometimes referred to as the “third absorption material 304”) comprises the material configured to absorb electromagnetic signals that fall within or overlap with the frequencies of communication signals conveyed by the cable 212, in an embodiment.

The signal suppressing device 308 is coupled to the cable 212 and spaced apart from the second absorption material 264. The signal suppressing device 308 is proximate to the second absorption material 264, but spaced apart from the second absorption material 264, in an embodiment. The signal suppressing device 308 comprises the material configured to absorb electromagnetic signals corresponding to in-band RE. For example, the signal suppressing device 308 (sometimes referred to as the “fourth absorption material 308”) comprises the material configured to absorb electromagnetic signals that fall within or overlap with the frequencies of communication signals conveyed by the cable 212, in an embodiment.

The third absorption material 304 and the fourth absorption material 308 have suitable lengths and thicknesses such as described above. In some embodiments, the third absorption material 304 has a same length and/or a same thickness as the first absorption material 260, and the fourth absorption material 308 has a same length and/or a same thickness as the second absorption material 264. In some embodiments, the third absorption material 304 has a suitable length and/or a suitable thickness different than the first absorption material 260, and the fourth absorption material 308 has a suitable length and/or a suitable thickness different than the second absorption material 264.

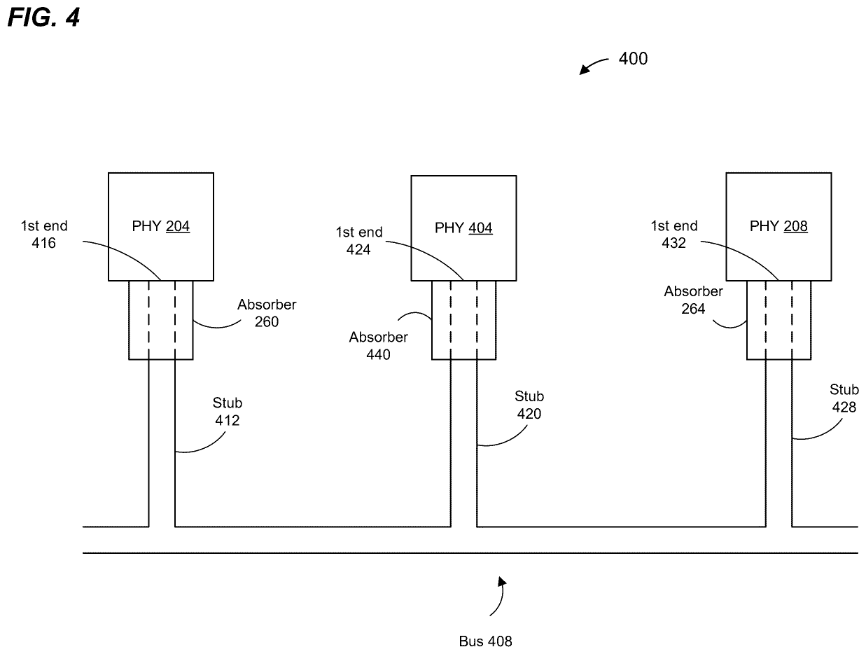

FIG. 4 is a simplified diagram of another example communication system 400 for use in a vehicle, according to an embodiment. The communication system 400 is utilized in the vehicle 100 of FIG. 1, in an embodiment, and FIG. 4 is described with reference to FIG. 1 merely for explanatory purposes. In other embodiments, the communication system 400 is utilized in another suitable vehicle different than the vehicle 100. In other embodiments, the vehicle 100 includes suitable communication systems different than the example communication system 400.

The communication system 400 includes the PHY circuitry 204, the PHY circuitry 208, and PHY circuitry 404. The PHY circuitry 404 has a structure the same as or similar to the PHY circuitry 204, in an embodiment. The PHY circuitry 404 has a suitable structure differently than the PHY circuitry 204, in another embodiment. The PHY circuitry 404 is included in a vehicle subsystem assembly 116, 120, 124, an ECU 104, a network switch, etc., in various embodiments.

The PHY circuitry 204, the PHY circuitry 208, and the PHY circuitry 404 are communicatively coupled via a bus 408. The bus 408 comprises a plurality of cable segments, and each cable segment comprises a suitable cable such as a cable used with Ethernet 10BASE-TIS, or another suitable cable. In an embodiment, the cable segments are interconnected via connectors (not shown).

The PHY circuitry 204 is communicatively connected to the bus 408 via a stub 412. The stub 412 comprises a suitable cable such as a cable used with Ethernet 10BASE-TIS, or another suitable cable. The stub 412 (sometimes referred to as the “cable 412”) has a first end 416 proximate to the PHY circuitry 204 and a second end (not shown) proximate to the bus 408. The stub 412 includes i) a first plug (not shown) connected to the first end 416 of the cable 412, and ii) a second plug (not shown) connected to the second end of the cable 412, in an embodiment. The second plug is used to connect the stub 412 to the bus 408, e.g., the bus 408 includes a socket for accepting the second plug.

The PHY circuitry 404 is communicatively connected to the bus 408 via a stub 420. The stub 420 comprises a suitable cable such as a cable used with Ethernet 10BASE-TIS, or another suitable cable. The stub 420 (sometimes referred to as the “cable 420”) has a first end 424 proximate to the PHY circuitry 404 and a second end (not shown) proximate to the bus 408. The stub 420 includes i) a first plug (not shown) connected to the first end 424 of the cable 420, and ii) a second plug (not shown) connected to the second end of the cable 420, in an embodiment. The second plug is used to connect the stub 420 to the bus 408, e.g., the bus 408 includes a socket for accepting the second plug.

The PHY circuitry 208 is communicatively connected to the bus 408 via a stub 428. The stub 428 comprises a suitable cable such as a cable used with Ethernet 10BASE-TIS, or another suitable cable. The stub 428 (sometimes referred to as the “cable 428”) has a first end 432 proximate to the PHY circuitry 208 and a second end (not shown) proximate to the bus 408. The stub 428 includes i) a first plug (not shown) connected to the first end 432 of the cable 4280, and ii) a second plug (not shown) connected to the second end of the cable 428, in an embodiment. The second plug is used to connect the stub 428 to the bus 408, e.g., the bus 408 includes a socket for accepting the second plug.

The first signal suppressing device 260 is coupled to the cable 412 proximate to the first end 416 of the cable 412 in a manner discussed above with reference to FIG. 2. The second signal suppressing device 264 is coupled to the cable 428 proximate to the first end 432 of the cable 428 in a manner discussed above with reference to FIG. 2.

A third signal suppressing device 440 is coupled to the cable 420 proximate to the first end 424 of the cable 420 in a manner such discussed above with reference to the first signal suppressing device 260 and the second signal suppressing device 264. The third signal suppressing device 440 comprises a material the same as or similar to the material(s) of the first signal suppressing device 260 and the second signal suppressing device 264, in an embodiment.

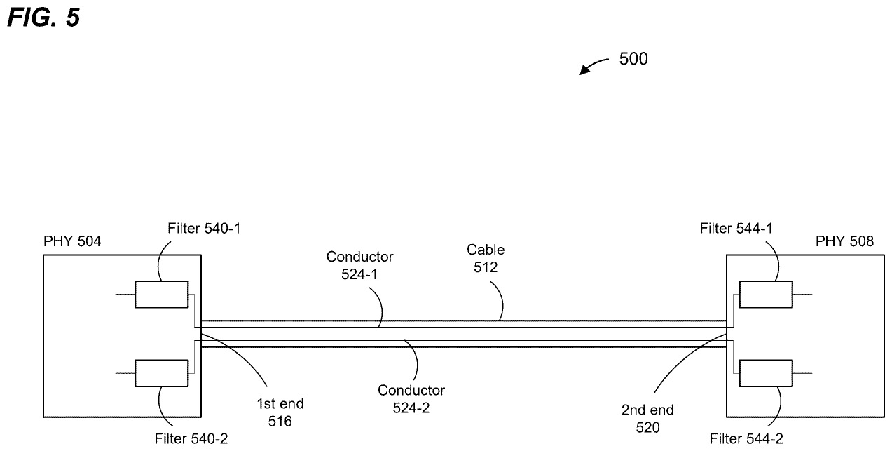

FIG. 5 is a simplified diagram of another example communication system 500 for use in a vehicle, according to another embodiment. The communication system 500 is utilized in the vehicle 100 of FIG. 1, in an embodiment, and FIG. 5 is described with reference to FIG. 1 merely for explanatory purposes. In other embodiments, the communication system 500 is utilized in another suitable vehicle different than the vehicle 100. In other embodiments, the vehicle 100 includes suitable communication systems different than the example communication system 500.

The communication system 200 includes PHY circuitry 504 of a first communication device and PHY circuitry 508 of a second communication device. The PHY circuitry 504 is communicatively coupled to the PHY circuitry 508 via a cable 512. The cable 512 comprises cable suitable for use in an in-vehicle communication system such as cables used with Ethernet 100BASE-T1, Ethernet 1000BASE-T1, IEEE 802.3ch compliant Multi-Gig Automotive Ethernet 2.5GBASE-T1, 5GBASE-T1, 10BASE-TIS, etc. In other embodiments, the cable 512 comprises another suitable cable.

In an embodiment, the PHY circuitry 504 corresponds to a first Ethernet network interface of the first communication device, and the PHY circuitry 508 corresponds to a second Ethernet network interface of the second communication device. In an embodiment, the PHY circuitry 504 and/or the PHY circuitry 508 have a structure the same as or similar to the PHY circuitry 204 (FIG. 2). In other embodiments, the PHY circuitry 504 and/or the PHY circuitry 508 have a suitable structure different than the PHY circuitry 204 (FIG. 2).

Referring to FIG. 1, in an embodiment, the first communication device having the PHY circuitry 504 corresponds to a vehicle subsystem assembly 116, 120, 124 and the second communication device having the PHY circuitry 508 corresponds to an ECU 104 or a network switch coupled to the ECU 104. In another embodiment, the first communication device having the PHY circuitry 504 corresponds to an ECU 104 and the second communication device having the PHY circuitry 508 corresponds to the network switch 108. In another embodiment, the first communication device having the PHY circuitry 504 corresponds to the network switch 108 and the second communication device having the PHY circuitry 508 corresponds to another network switch in the vehicle 100.

The cable 512 includes i) a first plug (not shown) connected to a first end 516 of the cable 512, and ii) a second plug (not shown) connected to a second end 520 of the cable 512, in an embodiment. The PHY circuitry 504 is coupled to a first socket (not shown) that is configured to accept the first plug of the cable 512, and the PHY circuitry 508 is coupled to a second socket (not shown) that is configured to accept the second plug of the cable 512. In an embodiment, when the first plug of the cable 512 is inserted in the first socket coupled to the PHY circuitry 504 and the second plug of the cable 512 is inserted in the second socket coupled to the PHY circuitry 508, the PHY circuitry 504 and the PHY circuitry 508 are communicatively connected via the cable 512.

The cable 512 includes a plurality of conductors 524, including a conductor 524-1 and a conductor 524-2. In some embodiments, the cable 512 includes more than two conductors 524. The conductors 524 are communicatively connected to the PHY circuitry 504 and the PHY circuitry 508.

The PHY circuitry 504 includes one or more signal suppressing devices 540 coupled to the cable 512 proximate to the first end 516 of the cable 512. More specifically, the PHY circuitry 504 includes one or more signal suppressing devices 540 communicatively coupled to respective conductors 524 proximate to the first end 516 of the cable 512.

The signal suppressing device(s) 540 each comprises a respective filter configured to attenuate electromagnetic signals corresponding to in-band RE. For example, the signal suppressing device 540-1 (sometimes referred to as the “filter 540-1”) comprises a shunt capacitor configured to attenuate electromagnetic signals that fall within or overlap with frequencies of communication signals conveyed by the cable 512, in an embodiment. In other embodiments, the filter(s) 540 each comprise a suitable filter different than a shunt capacitor. Although FIG. 5 illustrates two filters 540, the PHY 504 includes another suitable number of filters 540, such as one, three, four, etc., in other embodiments.

The PHY circuitry 508 includes one or more signal suppressing devices 544 coupled to the cable 512 proximate to the second end 520 of the cable 512. More specifically, the PHY circuitry 508 includes one or more signal suppressing devices 544 communicatively coupled to respective conductors 524 proximate to the second end 520 of the cable 512.

The signal suppressing device(s) 544 each comprises a respective filter configured to attenuate electromagnetic signals corresponding to in-band RE. For example, the signal suppressing device 544-1 (sometimes referred to as the “filter 544-1”) comprises a shunt capacitor configured to attenuate electromagnetic signals that fall within or overlap with frequencies of communication signals conveyed by the cable 512, in an embodiment. In other embodiments, the filter(s) 544 each comprise a suitable filter different than a shunt capacitor. For example, each of one or more of the filter(s) 544 comprises a first-order series inductor filter, a higher-order inductor-capacitor (LC) network, etc., to provide comparable damping of high-frequency resonances in UTP cables, in other embodiments. Although FIG. 5 illustrates two filters 544, the PHY 508 includes another suitable number of filters 544, such as one, three, four, etc., in other embodiments.

In embodiment, the PHY 504 comprises a socket (e.g., an Ethernet socket) and electrical conductors (e.g., traces on a printed circuit board (PCB)) electrically connected to the socket, and the filter(s) 540 are coupled to respective one(s) of the electrical conductors. In an embodiment, the PHY 504 comprises a PCB, and the filter(s) 540 are mounted on the PCB proximate to the first end 516 of the cable 512. In an embodiment, the PHY 504 comprises a PCB and a socket (e.g., an Ethernet socket), and the filter(s) 540 are mounted on the PCB proximate to the socket.

In embodiment, the PHY 508 comprises a socket (e.g., an Ethernet socket) and electrical conductors (e.g., traces on a printed circuit board (PCB)) electrically connected to the socket, and the filter(s) 544 are coupled to respective one(s) of the electrical conductors. In an embodiment, the PHY 508 comprises a PCB, and the filter(s) 544 are mounted on the PCB proximate to the second end 520 of the cable 512. In an embodiment, the PHY 508 comprises a PCB and a socket (e.g., an Ethernet socket), and the filter(s) 544 are mounted on the PCB proximate to the socket.

In an embodiment in which the filters 540, 544 comprise shunt capacitors, each shunt capacitor comprises an approximately 5 picofarad (pF) capacitor (e.g., 4.8-5.2 pF). In other embodiments in which the filters 540, 544 comprise shunt capacitors, each shunt capacitor comprises a suitable capacitor different than 5 pF.

In some embodiments in which the PHY 504 comprises a socket (e.g., an Ethernet socket), the filter 540 is included in the socket. In some embodiments in which the cable 512 comprises a plug (e.g., an Ethernet plug) at the first end 516 of the cable 520, the filter 540 is included in the plug. In some embodiments in which the PHY 508 comprises a socket (e.g., an Ethernet socket), the filter 540 is included in the socket. In some embodiments in which the cable 512 comprises a plug (e.g., an Ethernet plug) at the first end 516 of the cable 520, the filter 540 is included in the plug.

Although FIGS. 1-3 and 5 were described in the context of signal suppressing devices proximate to both ends of a cable, in other embodiments one or more signal suppressing devices are located proximate to only one end of a cable. For example, one or more signal suppressing devices located proximate to only one end of a cable may provide adequate suppression of in-band RE, and costs can be reduced as compared to a system in which signal suppressing devices are located proximate to both ends of the cable, in some embodiments. Similarly, although FIG. 4 was described in the context of signal suppressing devices proximate to first ends of all stubs connected to PHY devices, in other embodiments one or more signal suppressing devices corresponding to one or more stubs are omitted.

In some embodiments, techniques using a filter, such as described above with reference to FIG. 5, are combined with techniques using a signal suppression material, such as described with reference to FIGS. 2-4. For example, in-band RE is attenuated using i) a signal suppression material, such as described with reference to FIGS. 2-4, and ii) a filter, such as described above with reference to FIG. 5.

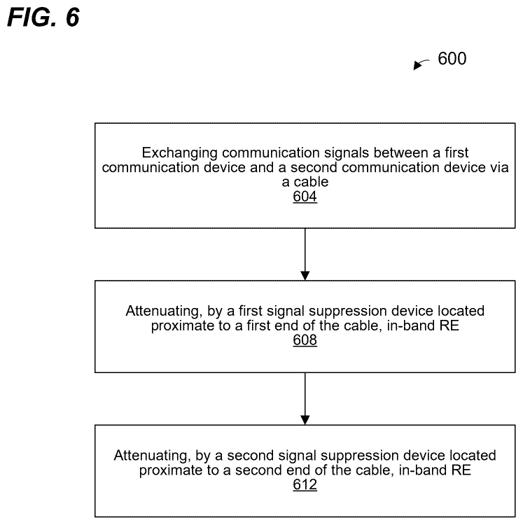

FIG. 6 is a flow diagram of an example method 600 for operating a communication network in a vehicle, according to an embodiment. The method 600 is implemented in the vehicle 100 of FIG. 1, the communication system 200 of FIG. 2, the communication system 300 of FIG. 3, the communication system 400 of FIG. 4, and/or the communication system 500 of FIG. 5, according to various embodiments, and FIG. 6 is described with reference to FIGS. 1-5 for ease of explanation. In other embodiments, the method 600 is implemented in another suitable vehicle/communication system different than the vehicle 100 and the communication systems of FIGS. 2-5.

At block 604, a first communication device of a vehicle and a second communication device of the vehicle exchange communication signals via one or more cable segments. For example, a first communication device of the vehicle 100 exchanges communication signals with a second communication device of the vehicle 100 via the cable 148, in an embodiment. As another example, a first communication device comprising the PHY device 204 exchanges communication signals with a second communication device comprising the PHY device 208 via a cable such as the cable 212, one or more cable segments of or connected to the bus 408, etc., in some embodiments. As another example, a first communication device comprising the PHY device 504 exchanges communication signals with a second communication device comprising the PHY device 508 via a cable such as the cable 512, in an embodiment.

At block 608, a first signal suppression device located proximate to a first end of the one or more cable segments attenuates in-band RE. For example, the signal suppression device 152 located proximate to a first end of the cable 148 attenuates in-band RE, in an embodiment. As another example, the signal suppression device 260 located proximate to the first end 216 of the cable 212 attenuates in-band RE, in another embodiment. As another example, the signal suppression device 260 located proximate to the first end 416 of the cable segment 412 attenuates in-band RE, in another embodiment. As another example, the signal suppression device(s) 540 located proximate to the first end 516 of the cable 512 attenuates in-band RE, in another embodiment.

At block 612, a second signal suppression device located proximate to a second end of the one or more cable segments attenuates in-band RE. For example, the signal suppression device 156 located proximate to a second end of the cable 148 attenuates in-band RE, in an embodiment. As another example, the signal suppression device 264 located proximate to the second end 220 of the cable 212 attenuates in-band RE, in another embodiment. As another example, the signal suppression device 264 located proximate to the first end 432 of the cable segment 428 attenuates in-band RE, in another embodiment. As another example, the signal suppression device(s) 544 located proximate to the second end 520 of the cable 512 attenuates in-band RE, in another embodiment.

In some embodiments, the block 612 is omitted.

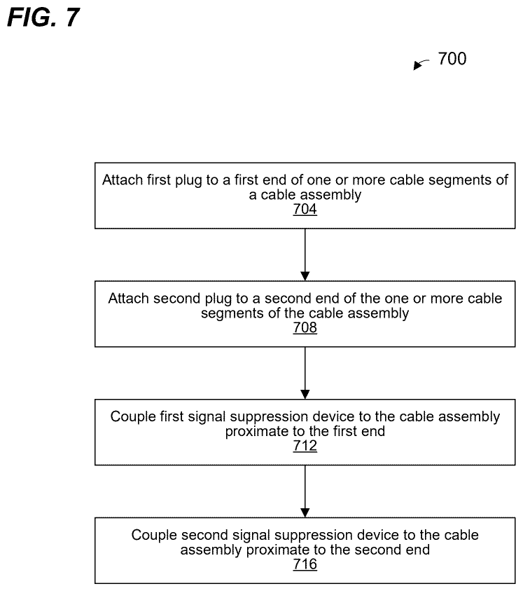

FIG. 7 is a flow diagram of an example method 700 for manufacturing a cable assembly for a communication network in a vehicle, according to an embodiment. Cables/cable assemblies such as described above with reference to FIGS. 1-6 are manufactured according to the method 700, according to various embodiments, and FIG. 7 is described with reference to FIGS. 1-6 for ease of explanation. In other embodiments, Cables/cable assemblies such as described above with reference to FIGS. 1-6 are manufactured according to one or more other suitable methods different than the method 700.

At block 704, a first plug is attached to a first end of one or more cable segments of the cable assembly.

At block 708, a second plug is attached to a second end of one or more cable segments of the cable assembly.

At block 712, a first signal suppression device is coupled to the cable assembly at a first location proximate to the first end of the cable assembly. For example, the first signal suppression device 152 is coupled to the cable 148 proximate to a first end of the cable 148, in an embodiment. As another example, the first absorption material 260 is coupled to the cable 212 proximate to the first end 216 of the cable 212, in another embodiment. As another example, the first absorption material 260 is coupled to the cable segment 412 proximate to the first end 416 of the cable segment 412, in another embodiment. As another example, the first signal suppression device(s) 540 is coupled to the cable 512 proximate to the first end 516 of the cable 512, in another embodiment.

The first signal suppressing device is configured to suppress signals in a frequency range corresponding to in-band RE, in an embodiment. The first signal suppressing device comprises a material configured to absorb electromagnetic signals corresponding to the in-band RE, in another embodiment. In an embodiment, coupling to the material to the cable assembly at block 712 comprises coupling to the material to the cable assembly so that the material surrounds a cable segment of the cable assembly at the first location. In an embodiment, coupling to the material to the cable assembly at block 712 comprises coupling to the material to the cable assembly so that the material circumscribes a cable segment of the cable assembly at the first location.

The first signal suppressing device comprises a filter configured to attenuate electromagnetic signals corresponding to the in-band RE, in another embodiment. In an embodiment in which the first signal suppressing device comprises a filter, the filter is included in the first plug.

At block 716, a second signal suppression device is coupled to the cable assembly at a second location proximate to the second end of the cable assembly. For example, the second signal suppression device 156 is coupled to the cable 148 proximate to a second end of the cable 148, in an embodiment. As another example, the second absorption material 264 is coupled to the cable 212 proximate to the second end 220 of the cable 212, in another embodiment. As another example, the second absorption material 264 is coupled to the cable segment 428 proximate to the first end 432 of the cable segment 428, in another embodiment. As another example, the second signal suppression device(s) 544 is coupled to the cable 512 proximate to the second end 520 of the cable 512, in another embodiment.

The second signal suppressing device is configured to suppress signals in a frequency range corresponding to in-band RE, in an embodiment. The second signal suppressing device comprises a material configured to absorb electromagnetic signals corresponding to the in-band RE, in another embodiment. In an embodiment, coupling to the material to the cable assembly at block 716 comprises coupling to the material to the cable assembly so that the material surrounds a cable segment of the cable assembly at the second location. In an embodiment, coupling to the material to the cable assembly at block 716 comprises coupling to the material to the cable assembly so that the material circumscribes a cable segment of the cable assembly at the second location.

The second signal suppressing device comprises a filter configured to attenuate electromagnetic signals corresponding to the in-band RE, in another embodiment. In an embodiment in which the second signal suppressing device comprises a filter, the filter is included in the second plug.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A communication system for use in a vehicle, comprising:
a first communication device configured for operation in the vehicle;
a second communication device configured for operation in the vehicle;
a cable assembly configured to communicatively couple the first communication device with the second communication device; and
a first signal suppressing device coupled to the cable assembly, the first signal suppressing device configured to suppress signals in a frequency range corresponding to in-band radiated emission (RE), the first signal suppressing device located proximate to a first end of the cable assembly.

2. The communication system of claim 1, further comprising:
a second signal suppressing device coupled to the cable assembly, the second signal suppressing device configured to suppress signals in the frequency range corresponding to the in-band RE, the second signal suppressing device located proximate to a second end of the cable assembly.

3. The communication system of claim 1, wherein the first signal suppressing device comprises an electromagnetic signal suppression material attached to the cable assembly at a location proximate to the first end of the cable assembly, the electromagnetic signal suppression material configured to suppress signals in the frequency range corresponding to the in-band RE.

4. The communication system of claim 3, wherein the electromagnetic signal suppression material surrounds a cable of the cable assembly at the location proximate to the first end of the cable assembly.

5. The communication system of claim 3, wherein the electromagnetic signal suppression material circumscribes a cable of the cable assembly at the location proximate to the first end of the cable assembly.

6. The communication system of claim 3, wherein the electromagnetic signal suppression material comprises at least one of i) a polymeric elastomer and ii) a dielectric foam.

7. The communication system of claim 3, wherein the electromagnetic signal suppression material comprises at least one of i) a conductive carbon, and ii) a ferrite.

8. The communication system of claim 1, wherein the first signal suppressing device comprises a filter configured to attenuate signals in the frequency range corresponding to the in-band RE.

9. The communication system of claim 8, wherein the filter comprises a shunt capacitor.

10. The communication system of claim 8, wherein the filter is included in the first communication device at a location within the first communication device that is proximate to the first end of the cable assembly.

11. A method for operating a communication system in a vehicle, comprising:
exchanging communication signals between a first communication device and a second communication device via a cable assembly; and
attenuating, by a first signal suppressing device coupled to the cable assembly proximate to a first end of the cable assembly, signals in a frequency range corresponding to in-band radiated emission (RE).

12. The method for operating the communication system of claim 11, wherein attenuating signals in the frequency range corresponding to the in-band RE comprises attenuating, by an electromagnetic signal suppression material attached to the cable assembly at a location proximate to the first end of the cable assembly, the signals in the frequency range corresponding to the in-band RE.

13. The method for operating the communication system of claim 12, wherein the electromagnetic signal suppression material surrounds a cable of the cable assembly at the location proximate to the first end of the cable assembly.

14. The method for operating the communication system of claim 11, wherein the first signal suppressing device comprises a filter configured to attenuate signals in the frequency range corresponding to the in-band RE.

15. The method for operating the communication system of claim 14, wherein the filter comprises a shunt capacitor.

16. A cable assembly for use in a vehicle, comprising:
one or more cable segments;
a first plug connected to a first end of the one or more cable segments;
a second plug connected to a second end of the one or more cable segments; and
a first signal suppressing device coupled to the cable assembly, the first signal suppressing device configured to suppress signals in a frequency range corresponding to in-band radiated emission (RE) in the vehicle, the first signal suppressing device located proximate to the first end of the cable assembly.

17. The cable assembly of claim 16, further comprising:
a second signal suppressing device coupled to the cable assembly, the second signal suppressing device configured to suppress signals in the frequency range corresponding to the in-band RE in the vehicle, the second signal suppressing device located proximate to the second end of the cable assembly.

18. The cable assembly of claim 16, wherein the first signal suppressing device comprises an electromagnetic signal suppression material attached to the cable assembly at a location proximate to the first end of the cable assembly, the electromagnetic signal suppression material configured to suppress signals in the frequency range corresponding to the in-band RE.

19. The cable assembly of claim 16, wherein the first signal suppressing device comprises a filter configured to attenuate signals in the frequency range corresponding to the in-band RE.

20. The cable assembly of claim 16, wherein the filter is included in the first plug.
